(19) United States
(12) Patent Application Publication
(10) Pub. No.: US 2025/0314816 A1
(43) Pub. Date: Oct. 9, 2025

(54) QUANTUM ENTANGLEMENT DEVICE AND METHOD OF MANUFACTURE

(71) Applicant: VIRGINIA TECH INTELLECTUAL PROPERTIES, INC., Blacksburg, VA (US)

(72) Inventor: Gary Pickrell, Shawsville, VA (US)

(21) Appl. No.: 18/865,979

(22) PCT Filed: May 17, 2023
(86) PCT No.: PCT/US2023/067108

§ 371 Date: Nov. 14, 2024

Related U.S. Application Data
(60) Provisional application No. 63/364,840, filed on May 17, 2022.

(51) Int. Cl. G02B 6/02; B82Y 20/00; C03B 37/012; G02F 1/365

(52) U.S. Cl. CPC G02B 6/0229; B82Y 20/00; C03B 37/01211; C03B 37/01265; G02B 6/02347; G02B 6/02361; G02F 1/365; G02F 2202/32

(57) ABSTRACT

A quantum entanglement device and a method of manufacture thereof are described. Specifically, an optical fiber for generating entangled photons is described that includes an optical core and photon entanglement media disposed relative to the optical core. The photon entanglement media includes at least one non-linear crystal, such as Barium Borate. A method of manufacturing an optical fiber is also described that includes providing a fiber preform that contains a nonlinear optical crystal within it, heating the fiber preform until the fiber preform reaches a predetermined temperature, and drawing the optical fiber form the preform, thereby generating an optical fiber having a photon entanglement media disposed therein, where the photon entanglement media comprises at least one non-linear crystal.

### CROSS-REFERENCE TO RELATED APPLICATION

This application claims the benefit of and priority to U.S. Provisional Patent Application No. 63/364,840 filed May 17, 2022, entitled “QUANTUM ENTANGLEMENT DEVICE AND METHOD OF MANUFACTURE,” the entire contents of which is hereby incorporated herein by reference.

### TECHNICAL FIELD

The present invention relates to the field of quantum physics and, more specifically, to an optical device configured to generate and manipulate entangled photon pairs for applications in quantum communication, quantum computing, and related fields.

### BACKGROUND

Quantum entanglement, a phenomenon in quantum physics, allows for the generation of correlated particle pairs that exhibit non-classical correlations, enabling various applications in quantum information processing. For instance, when a photon is passed through a crystal or optical device that has certain non-linear optical properties, the photon can split into two different photons. These photons can be entangled is various ways, one of them being polarization entanglement. The resulting photons are “entangled,” meaning that a polarization state of a first photon is dictated by the polarization state of the other photon. Beta-Barium Borate (BBO) crystals and the like are used in generating entangled protons. Various challenges exist in increasing the efficiency or likelihood of a generating a pair of entangled photons. Currently, when a photon is passed through a crystal or like optical device, the chances of generating a pair of entangled photons are remote. Moreover, existing methods for generating entangled photon pairs often require complex and expensive setups, limiting their practicality and scalability.

### BRIEF SUMMARY

In a first aspect, a method of manufacturing an optical fiber is described. In one example, the method includes providing a fiber preform, heating the fiber preform in a draw tower until the fiber preform reaches a predetermined temperature, and then drawing the preform into an optical fiber. The fiber preform used in the drawing process can be formed or manufactured by heating a crystal material or composition in a suitable crucible which is placed into a furnace and heated to a temperature above the melting point of the crystal material, inserting a glass tube into the heated crucible containing the molten crystal, applying suction to draw the crystal material into the glass tube, and cooling the glass tube and the crystal composition disposed therein. Any number of tubes of crystal material can be formed in a similar way.

One or more such glass tubes containing the crystal material can be inserted into holes or apertures formed in a larger glass tube preform, where the outer diameter of the glass tube containing the crystal matches the inner diameter of the holes in the larger glass tube preform. If more than one crystal region inside the fiber is desired, more tubes containing the crystal material can be inserted into any number of holes in the larger glass tube preform.

Additionally, an optical fiber core rod (e.g., a glass rod with the composition that is desired to be in the core region as is generally known by one skilled in the art) can be inserted into a center hole of the larger glass tube preform, and the glass tubes containing the crystal material can be arranged either symmetrically or asymmetrically around the core rod. In some cases, more than one core rod can be used in conjunction with one or more tubes of crystal material dispersed symmetrically or asymmetrically within the fiber preform.

Different crystal composition materials can be incorporated into the fiber preform by inserting the tubes in the desired location and having the desired crystal composition in each tube. The preform generated in this manner having one or more crystal material regions with one or more cores can be mounted and drawn in a draw tower, thereby generating an optical fiber with at least one photon entanglement media disposed therein. The photon entanglement media can include at least one non-linear crystal, where the at least one non-linear crystal has a predetermined size and a predetermined location in the optical fiber through controlling of size and location of the crystal material in the preform. The drawing parameters of temperature of the preform, speed with which the glass fiber is drawn and cooling rate of the optical fiber (which can be controlled by utilizing a tube furnace below the draw tower furnace), in addition to the crystal material region size and location within the preform, can be varied to control the size of the crystals in the crystal material containing regions which reside inside the optical fiber after drawing.

The at least one non-linear crystal can be a plurality of non-linear crystals. The plurality of non-linear crystals can include a first collection of non-linear crystals at a first location of the optical fiber and a second collection of non-linear crystals at a second location of the optical fiber. The crystals which could be used include but are not limited to beta Barium Borate (BBO) crystals, KTP (KTiOPO₄), LiO₃, DKOP, LiNbO₃, KTA, AgS, CdSe, GaSe, CLBO, Yb:YAG, BiBO₃, Barium Titanate, silicon crystals, other non-linear crystals, or a combination thereof.

In a second aspect, an optical device for quantum entanglement generation manipulation and detection is described. The device can include a pump photon source module configured to generate photons of the appropriate wavelength, an optical fiber containing crystal material regions, and a photon detection module configured to measure and characterize the entangled photon pairs.

The photon source module is further configured to produce photons of the desired wavelength and within a spectrally narrow bandwidth (tuned to the necessary wavelength for entanglement for the crystal used within the fiber). The source of photons is coupled into the optical fiber which contains the non-linear crystal which can be a Barium Borate (BBO) crystal or other non-linear crystal which is selected from a group containing: KTP (KTiOPO₄), LiO₃, DKOP, LiNbO₃, KTA, AgS, CdSe, GaSe, CLBO, Yb:YAG, BiBO₃, Barium Titanate, silicon crystals, other non-linear crystals, or a combination thereof. The source photons travelling through the optical fiber interact with the nonlinear crystal material which transforms the source photon at one energy (and wavelength) into 2 photons each with ½ the energy (and correspondingly, double the wavelength). For example, with the use of Barium Borate (BBO) in the fiber, an incoming source photon with a 405 nm wavelength would be split into two photons each with a wavelength of 810 nm. The two photons produced can be polarization entangled, meaning that the polarization state of one depends upon the polarization state of the other.

In this manner, the source photons are converted inside the optical fiber into polarization entangled photons which can be guided inside the optical fiber. It is well known to one skilled in the art that photons can be guided inside an optical fiber. The entangled photons can be guided inside the optical fiber in the same manner that optical fibers are used conventionally today except that the photons are polarization entangled. The optical fiber can be connected to an optical fiber splitter or coupler, which is well known to one skilled in the art, in order to split the optical signal containing the entangled photons into two equal signals, which propagate in the two separate fiber sections of the coupler. The two fiber sections of the coupler can be directed to the detection system. The photon detection module can include a high-performance single-photon detector and associated electronics configured to measure and characterize the entangled photon pairs.

In a third aspect, an optical fiber for generating entangled photons is described. The optical fiber can include an optical core and photon entanglement media disposed relative to the optical core. The photon entanglement media can include at least one non-linear crystal, where the at least one non-linear crystal is positioned in the optical fiber such that a multitude of photon and crystal interactions occur in a single transmission of the photons. The at least one non-linear crystal can be a plurality of non-linear crystals. At least a portion of the plurality of non-linear crystals can be Barium Borate (BBO) crystals. A least a portion of the plurality of non-linear crystals can include KTP (KTiOPO₄), LiO₃, DKOP, LiNbO₃, KTA, AgS, CdSe, GaSe, CLBO, Yb:YAG, BiBO₃, Barium Titanate, silicon crystals, other non-linear crystals, or a combination thereof.

In a fourth aspect, a method is described, including generating an entangled photon pair using the optical fiber and a photon source described herein, directing the entangled photon pair through a transmission end of the optical fiber, and detecting the entangled photon pair on a receiving end of the optical fiber. The method further includes performing a secure communication using the entangled photon pair. The method further includes performing cryptography using the entangled photon pair. The photon source is a laser configured to emit photons at a predetermined wavelength.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIGS. 1A-1D illustrate sectional views of quantum entanglement devices according to various embodiments of the present disclosure.

FIG. 2 is an optical micrograph of a cross-section of a fiber according to various embodiment of the present disclosure.

FIG. 3 is an optical micrograph of a cross-section of a fiber according to various embodiment of the present disclosure.

FIG. 4 is an optical micrograph of a cross-section of a fiber according to various embodiment of the present disclosure.

FIG. 5 is an optical micrograph of a cross-section of a fiber according to various embodiment of the present disclosure.

FIG. 6 is an example flowchart for a process of forming a quantum entanglement device according to various embodiments of the present disclosure.

FIG. 7 is a schematic diagram of an optical device for quantum entanglement according to various embodiments of the present disclosure.

FIG. 8 is a scanning electron microscope (SEM) image of an optical fiber having beta-barium borate disposed therein according to various embodiments of the present disclosure.

FIG. 9 is an optical microscope image of an optical fiber having beta-barium borate disposed therein for comparison with the SEM image of FIG. 8 according to various embodiments of the present disclosure.

FIG. 10 a chart illustrating energy dispersion spectroscopy data depicting element of labeled Spectrum 2, shown in FIG. 11, inside the lighter ring, which illustrates presence of BBO in the optical fiber according to various embodiments of the present disclosure.

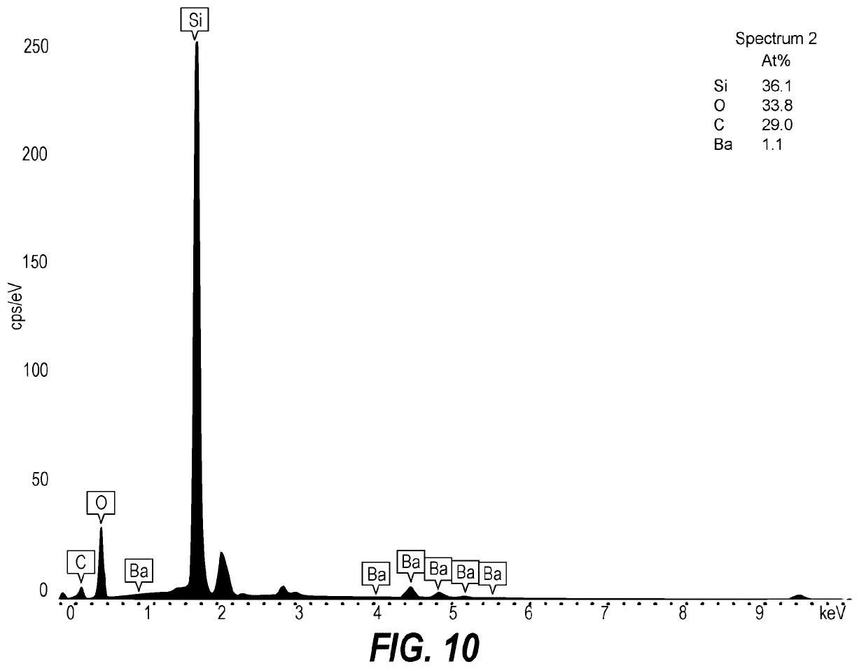

FIG. 11 an enlarged view of a portion of the SEM image of FIG. 8 depicting Spectrum 1 and Spectrum 2 according to various embodiments.

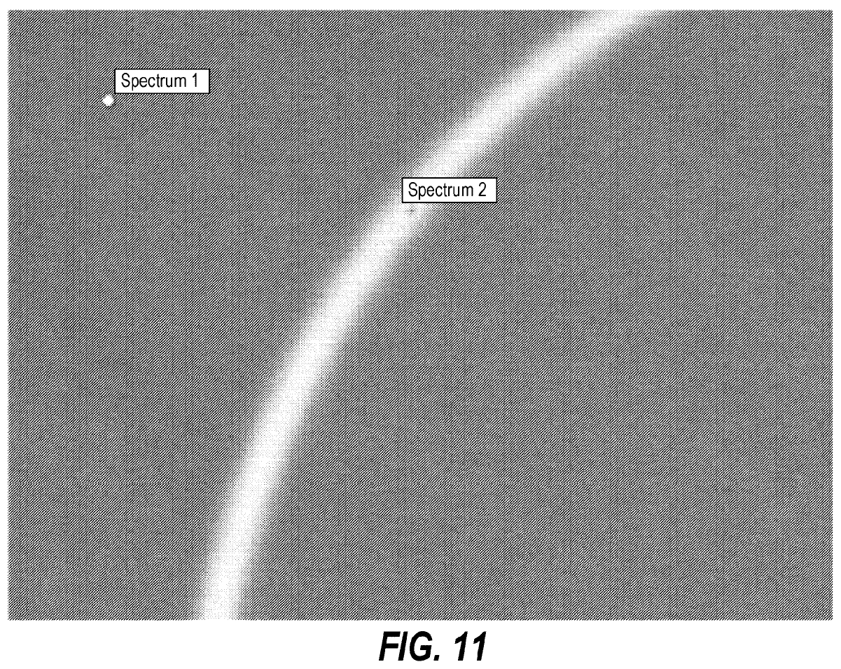

FIG. 12 is an SEM image showing elemental distributions in core and cladding regions of an optical fiber according to various embodiments of the present disclosure.

FIG. 13 is an energy-dispersive x-ray spectroscopy (EDAX) image showing elemental distributions in core and cladding regions of an optical fiber according to various embodiments of the present disclosure.

### DETAILED DESCRIPTION

The embodiments described herein relate to a quantum entanglement device and a method of manufacture thereof. Quantum entanglement is a fundamental phenomenon in quantum physics that describes the correlation between two or more particles, such as photons, that are inextricably linked, regardless of the distance between them. It has numerous applications in fields such as quantum computing, cryptography, and communication. Existing methods for generating entangled photon pairs often require complex and expensive setups, limiting their practicality and scalability. As such, there is a need for an improved optical device that simplifies the generation and manipulation of entangled photons while maintaining high levels of entanglement fidelity and photon pair purity.

Even further, certain crystals, such as Barium Borate (BBO) crystals, may be employed to produce quantum entangled photons. When a photon is passed through a crystal or like optical device, the chances, however, of generating a pair of entangled photons are very low. As such, the process is extremely inefficient due to low probabilities of entanglement upon interaction of a photon with the crystal. However, if a beam of transmitted photons were transmitted and placed back through the crystal or like optical device, the probability of generating an entangled photon pair is increased.

Accordingly, the present disclosure provided various embodiments for an optical device that facilitates the generation and manipulation of entangled photon pairs. For instance, in various embodiments, a desired type of crystal or multitude of crystals, such as a BBO crystal or crystals, are placed into or otherwise positioned in an optical fiber. In some embodiments, one or more crystals are placed in a core or in a cladding region to allow light to interact a large number of times with a crystal or a multitude of crystals. A single large crystal or a very large number of tiny crystals may be incorporated into the optical fiber to allow extremely large numbers of photon and crystal interactions to occur. Various configurations may be achieved between multiple crystal regions and multiple optical core regions for further optimization.

Further, in various embodiments, an optical device is described that is a compact and robust apparatus that incorporates advanced optical components, including photon sources, wave plates, beam splitters, and detectors. The optical device generates highly entangled photon pairs with enhanced efficiency, purity, and stability. Moreover, the device incorporates features for precise control and manipulation of entanglement properties, such as entanglement swapping, entanglement purification, and entanglement distribution over long distances.

Additional components of the quantum entanglement device are to be described, followed by a discussion of manufacturing of the same.

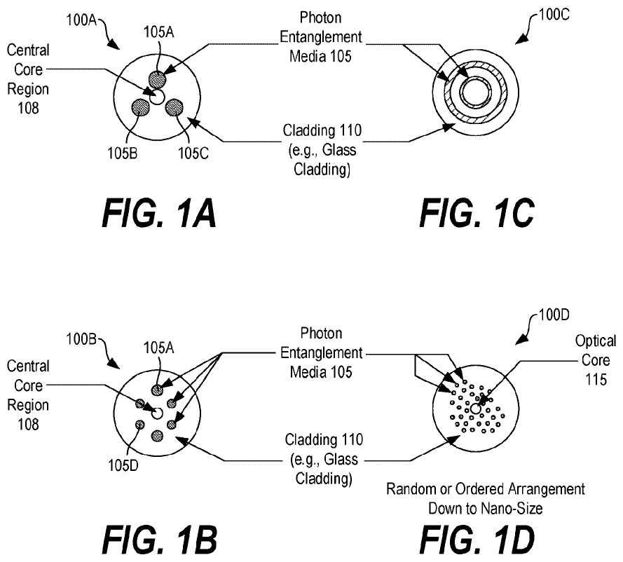

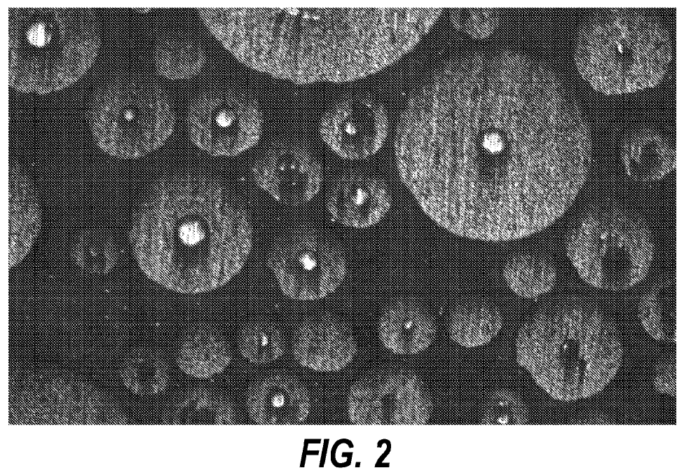

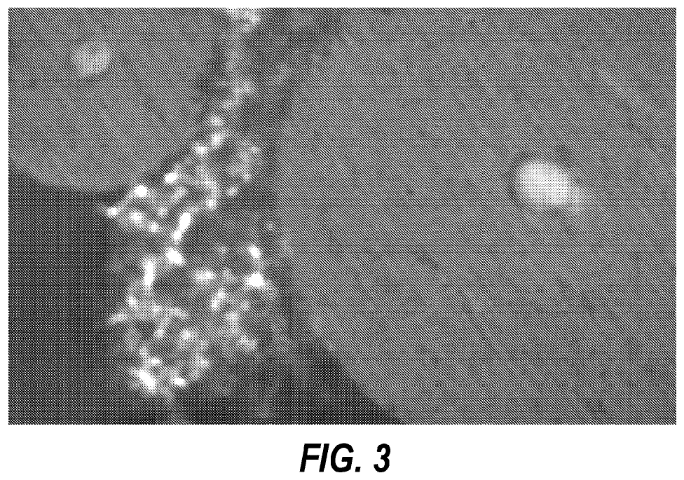

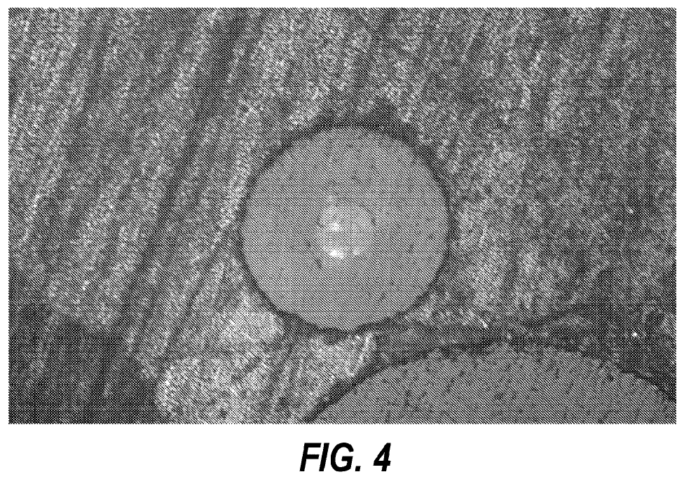

Turning now to the drawings, FIGS. 1A-1D illustrate sectional views of quantum entanglement devices, where the quantum entanglement devices may include a waveguide, such as a quantum entanglement optical fiber, referred to herein as an optical fiber for short. Particularly, FIG. 1A illustrates a quantum entanglement optical fiber 100A, FIG. 2 illustrates a quantum entanglement optical fiber 100B, FIG. 3 illustrates a quantum entanglement optical fiber 100C, and FIG. 4 illustrates a quantum entanglement optical fiber 100D (collectively “optical fibers 100”). The optical fibers 100 are provided as representative examples in FIGS. 1A-ID, although other types of waveguides can be employed. The optical fibers 100, and the features or elements of the optical fibers 100, are not necessarily drawn to scale in FIGS. 1A-1D. In some cases, the optical fibers 100 can include additional elements or features as compared to those shown. In other cases, the optical fibers 100 can omit one or more of the elements or features shown. Sectional views of the optical fibers 100 are shown in FIGS. 1A-1D, and the optical fibers 100 can be manufactured to a range of lengths (e.g., lengths extending into and out of the page) according to the concepts described herein.

Referring first to FIG. 1A, the optical fiber 100A includes regions of photon entanglement media 105A, 105B, and 105C (collectively “regions of photon entanglement media 105” or separately “region 105A,” “region 105B,” and “region 105C”), a central core region 108, and cladding 110, among possibly other components. The photon entanglement media 105 may include, for example, a single crystal or a multitude of different types of crystals formed or otherwise incorporated into the optical fiber 100A by controlling time exposure and/or temperature exposure, as will be described. The optical fiber 100A may allow for large numbers of photon-to-crystal interactions to occur.

The crystals in the regions of photon entanglement media 105 can be the same among the regions 105A-105C in one example. In other examples, crystals among the regions of photon entanglement media can be different among the regions 105A-105C. In each of the regions 105A-105C, the crystals may include non-linear crystals, such as BBO, KTP (KTiOPO₄), LiO₃, DKOP, LiNbO₃, KTA, AgS, CdSe, GaSe, CLBO, Yb:YAG, BiBO₃, Barium Titanate, silicon crystals, other non-linear crystals, or a combination thereof. A non-linear crystal is a material that exhibits non-linear optical properties, meaning its refractive index changes with the intensity of light passing through it. As such, non-linear crystals generate entangled photon pairs through spontaneous parametric down-conversion (SPDC). Common examples of non-linear crystals used for this purpose include BBO, KTP, and so forth. Each of the regions 105A-105C can include the same type of crystal in one example. In another example, each of the regions 105A-105C can include a different type of crystal as compared to each other. In still other examples, two or more of the regions 105A-105C can include the same type of crystal, and other regions 105A-105C can include a different type of crystal.

Generally, a large number of different configurations can be achieved between multiple crystal regions and multiple optical core regions for further optimization. For example, the optical fibers 100 can include less than or more than three regions of photon entanglement media 105. Some of the potential configurations are shown in FIGS. 1A-1D. In FIG. 1A, the optical fiber 100A includes three regions of photon entanglement media 105 incorporated in a circular region or arrangement around a central core region 108. The central core region 108 may include an optical core, as may be appropriate. The central core region 108 can be embodied as a cylindrical region of glass or plastic material suitable for guiding light in the optical fiber 100A. In general, any number of regions of photon entanglement media 105 can be incorporated in the fiber 100A and these may either be symmetrically disposed around the central core region 108 or not symmetrically arranged. The cladding 110 around the regions of photon entanglement media 105 and the central core region 108 can be embodied as a glass or other suitable cladding material.

FIG. 1B shows an optical fiber 100B having differing sizes of the regions of the photon entanglement media 105 and, in general, a variety of distributions of these sizes may be employed. For example, the region of photon entanglement media 105A is larger in diameter than the region of photon entanglement media 105D. Additionally, the optical fiber 100B includes a greater number of the regions of photon entanglement media 105 than the fiber 100A shown in FIG. 1A.

FIG. 1C shows regions of the photon entanglement media 105 arranged in rings around a central core region 108. FIG. 1D illustrates an optical fiber 100D including an optical core 115, such as pure silica or germanium-doped silica, in the center of the optical fiber 100D with the photon entanglement media arranged 105 in a random fashion therearound.

In addition to a core, the optical fibers 100 of the embodiments of FIGS. 1A-1D may include cladding 110, a coating (not shown) surrounding the cladding 110, a strength member (not shown), an outer jacket (not shown), as well as other components understood in the art as being included in optical fibers, as may be appreciated. The cladding 110 may include glass cladding or other suitable cladding according to various embodiments. The glass cladding 110 may provide a lower reflective index than the optical core 115 in some embodiments.

In general, a variety of materials and/or structures that are used commercially for forming core regions of optical fibers 100 may be incorporated into the optical fiber 100 as the central core region 108 or as the optical core 115, so as to minimize the loss of an optical signal propagating in the core region. The optical fibers 100 may be designed such that an evanescent field emanating from the central core region 108 or the optical core 115 into the cladding 110 can be used to allow interaction of light with the photon entanglement media 105 in the cladding 110.

In various embodiments, the size (i.e., sectional diameter) of the regions of photon entanglement media 105 may be in a range from hundreds of microns down to a few nanometers, although other dimensions may be employed. A number of the regions of the photon engagement media 105 may be larger (e.g., greater than tens of thousands of microns) for very small crystals. Accordingly, the size and size distribution, location, and/or composition of the photon entanglement media 105, ordering level, and number of regions can be controlled over a very wide range depending, for instance, on a desired application.

The optical fibers 100 or like quantum entanglement device may be employed in a variety of different applications, from sensing applications to imaging applications to communications to cryptography. To date, there is no easy and efficient way to generate a large number of entangled photons in a device. The optical fibers 100, however, can be configured to generate and manipulate entangled photon pairs for applications in quantum communication, quantum computing, and related fields.

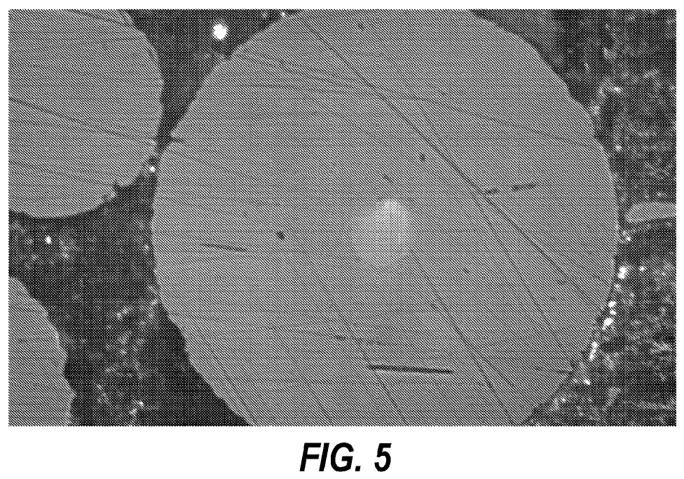

Accordingly, various embodiments for an optical fiber 100 or other like quantum entanglement device are disclosed that may incorporate a variety of desired crystals such, as BBO, into an optical fiber either in a core or in cladding 110, to allow light to interact a large number of times with the crystal or crystals. Example fibers which have been produced with a barium borate core, as disclosed in the embodiments described herein, are shown in FIGS. 2-5. Specifically, a micrograph of FIG. 2 shows a composite picture of many different fiber cross-sections with different core sizes and different cladding 110 glass diameters. FIGS. 3, 4, and 5 are enlarged photographs of some of these fibers.

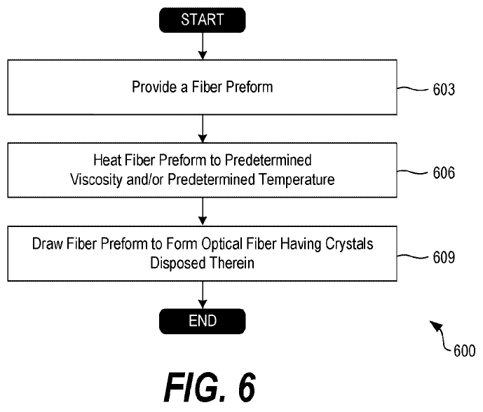

FIG. 6 includes a flowchart 600 that describes an example process for manufacturing one or more of the optical fibers 100 shown in FIGS. 1A-1D or like photon entanglement devices. In addition, the process of the flowchart 600 of FIG. 6 describes controlling a size and/or location of a crystal (or collection of crystals) in optical fibers 100 or like devices. For instance, an optical fiber 100 may be formed having a first collection of crystals at a first location of the optical fiber 100, a second collection of crystals at a second location of the optical fiber 100, a third collection of crystals at a third location of the optical fiber 100, and so forth, where the collections of crystals and the locations may be different from one another.

At box 603, the process includes providing or otherwise forming a fiber preform. The fiber preform can be used to form an optical fiber according to the embodiments described herein, such as one of the optical fibers 100A, 100B, 100C, or 100D, among others.

At box 603, the process further includes melting one or more crystals or crystal materials. The crystals can include non-linear crystals, such as BBO, KTP (KTiOPO₄), LiO₃, DKOP, LiNbO₃, KTA, AgS, CdSe, GaSe, CLBO, Yb:YAG, BiBO₃, Barium Titanate, silicon crystals, other non-linear crystals, or a combination thereof. The crystal or crystals can be melted in a crucible in a furnace, for example, to a temperature above the melting point of the crystals. Other suitable techniques can be relied upon to melt the crystal or crystals to a temperature above the melting point. Depending on the type of optical fiber being formed, the process can include melting a number of different crystal materials separately.

At box 603, the process further includes suctioning the melted crystal material or materials into one or more tubes. The tube or tubes can be glass tubes in one example. The tubes can have the same or different outer diameters (“ODs”). The tubes can ultimately form part of the cladding of the optical fiber being formed in the process. The tube or tubes can be inserted, at one end, in the melted crystal material or materials. Suction can be applied to the tube or tubes, at another end, to draw the melted crystal material or materials into the tube or tubes. After the crystal material or materials have been drawn up into the tube or tubes, the tubes and crystal materials can be cooled. These tubes of crystal materials can be used to form the regions of photon entanglement media 105 in the optical fibers 100 shown in FIGS. 1A-1D, for example. Tubes having a range of different ODs can be used to form regions of photon entanglement media 105 having different cross-sectional diameters.

At box 603, the process further includes inserting the tube or tubes containing the crystal material or materials into a larger glass tube preform. The glass tube preform can have one or more holes or apertures formed in it, at locations in which the regions of photon entanglement media are to be positioned in the resulting optical fiber. The glass tube preform can have any number of holes formed in it, at various locations. The holes can be arranged symmetrically, such as in a ring or circle, or asymmetrically or randomly, consistent with the examples described above in FIGS. 1A-1D. Each of the holes can have an inner diameter (“ID”) that is sized large enough for insertion of one of the tubes containing the crystal material or materials. The glass tube preform can thus include a number of different holes or apertures having different IDs, each matching (although larger than) the ODs of the tubes containing the crystal material or materials.

The tube or tubes containing the crystal material or materials can be inserted into the holes within the larger glass tube preform at the desired locations. Additionally, an optical fiber core rod can be inserted into a central hole within the glass tube preform, to form the central core region. This optical fiber core rod can ultimately form the central core 108 or the optical core 115 of an optical fiber 100, consistent with the examples described above in FIGS. 1A-1D.

At box 606, the process can include heating the fiber preform formed at box 603 to a predetermined viscosity, to a predetermined temperature, or to both a predetermined viscosity and temperature. In one example, the fiber preform can be placed into a draw tower for forming fibers and heated in the draw tower. At box 609, the process can include drawing the fiber preform, after heating, into an optical fiber. Here, the fiber preform can be pulled at one end, for example, and stretched or drawn out into the optical fiber. The drawing process can be facilitated to some extent by gravity, although the fiber preform can also be pulled or stretched. The fiber preform can be pulled to a suitable length for the desired application for the resulting optical fiber. The optical fiber can be one of the optical fibers 100A-100D shown in FIGS. 1A-1D, as examples.

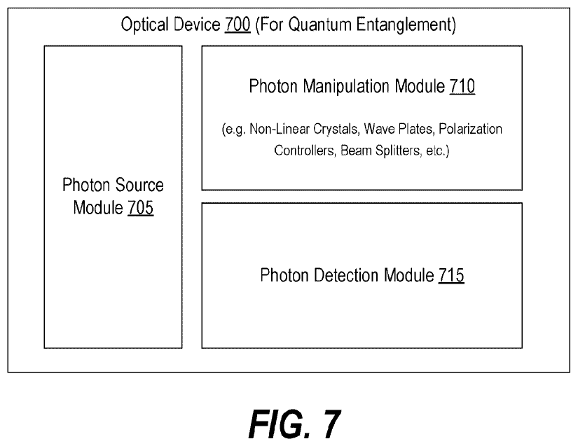

Turning now to FIG. 7, a schematic diagram of an optical device 700 for quantum entanglement is shown according to various embodiments. Generally, the optical device 700 can include a photon source module 705, a photon manipulation module 710, and a photon detection module 715.

The photon source module 705 can utilize nonlinear optical processes, such as spontaneous parametric down-conversion or four-wave mixing, to generate entangled photon pairs with desired characteristics in an optical fiber comprising a non-linear crustal material disposed within. The photon source module 705 can generate entangled photon pairs in one of the optical fibers described herein, such as one of the optical fibers 100A, 100B, 100C, or 100D, as examples. The photon manipulation module 710 can incorporate various optical elements, such as wave plates, polarization controllers, beam splitters, and any combination thereof, to modify and control entanglement properties of generated photon pairs. The photon detection module 705 can include high-performance single-photon detectors and associated electronics for efficient measurement and characterization of the entangled photons in the optical fiber.

In addition to the optical device 700, a quantum entanglement system can include a photon source, a pump laser (e.g., an ultraviolet diode laser), a control and stabilization system, among other devices. The photon source can include a laser or other suitable light source that provides necessary light input for the quantum entanglement process. The laser can emit photons at a predetermined wavelength, which determines the energy and properties of the entangled photon pairs generated. The wavelength as emitted by the laser can be preselected based on a type of non-linear crystal or crystals in the optical fiber. The pump laser is a high-intensity laser that stimulates non-linear crystals, initiating a SPDC process. For instance, the pump laser can generate photons at a specific frequency that matches the phase-matching conditions of the non-linear crystal or crystals in the optical fiber.

In some implementations, if the polarization of a pump beam generated by a pump laser and the axis of the BBO crystal are matched in a way enabling energy and momentum conservation, a portion of the pump photons can be converted into two lower energy near infrared photons at 810 nm. These photons then emerge at opposite sides of an emission cone and form an entangled photon pair.

Phase matching can be performed to ensure efficient SPDC and the generation of entangled photon pairs. Phase matching can thus include matching the propagation velocities and phase velocities of the photons. Proper alignment and control of orientation, temperature, and other factors of a non-linear crystal can be employed to achieve phase matching.

To ensure the stability and reliability of the entanglement generation process, precise control of environmental factors such as temperature, vibration, and electromagnetic interference can be achieved in the quantum entanglement system. Active stabilization techniques can further be employed to maintain the alignment and phase matching conditions throughout the experiment. By combining the foregoing components and carefully controlling their parameters, quantum entanglement in an optical fiber 100 can be achieved using non-linear crystals. This enables applications such as long-distance quantum communication, quantum cryptography, and quantum networking.

For a quantum entangled photon generating fiber, an optical fiber 100 can contain second order nonlinear crystallinity able to interact with light propagating through the optical fiber 100.

As described above, a process to form BBO crystals inside an optical fiber 100 is described for getting solid BBO inside a fiber preform. To do this, a nonlinear crystal can first be heated up to its melting temperature of approximately 1100° C. inside an alumina crucible for liquification. Fused silica tubes can thus be produced with liquid BBO pulled up through the tube cavity to be later set in a fiber preform for drawing. This can be performed by attaching one end of the glass tube to a low powered vacuum and the other submerged inside the molten pool of BBO.

The liquid BBO, due to the vacuum, can be forced into the tube cavity to begin crystalizing. The tubes containing the crystal material can be inserted into a larger glass tube with a hole that matches closely the diameter of the crystal material containing tube. One or more tubes can be positioned in the larger tube. Each tube can contain the same or different crystal material. The larger tube can also contain one or more optical core regions. An optical fiber can then be made from the preform setup using a fiber draw tower while demonstrating relative ease for the actual draw process comparable to that of standard telecom fibers.

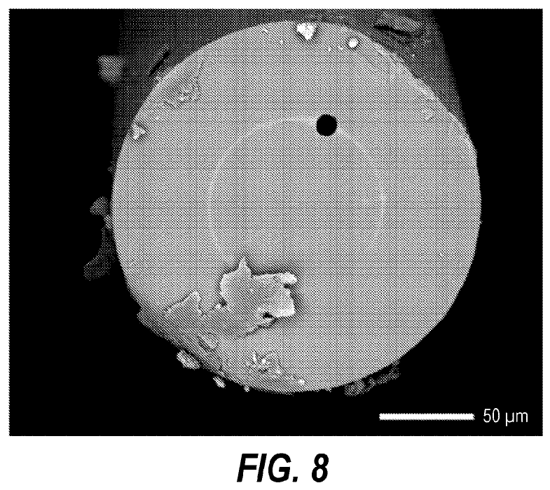

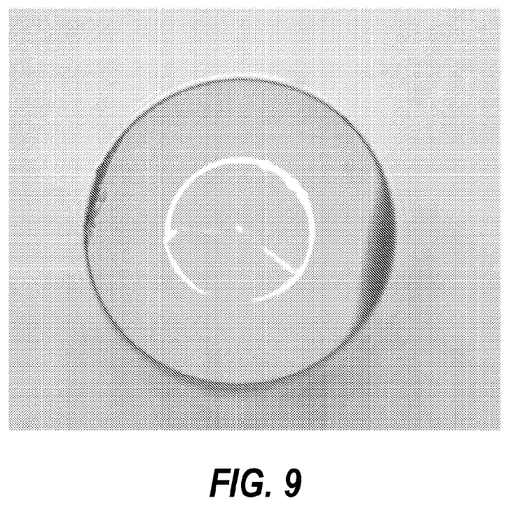

In accordance with various methods described herein, optical fibers 100 containing BBO were fabricated and then characterized. From SEM imaging and an energy dispersive spectral analysis, shown in FIGS. 8 and 9, it can be determined that barium is present in the rings surrounding the core and in the core itself of both fiber samples. The presence of these elements indicates that during the draw process, second order nonlinear BBO crystals permeate the lighter colored core and lighter colored patterns throughout the samples as shown in FIGS. 8 and 9.

Based on the drawing process and kinetics of the BBO crystallization, it can be determined that there is a wide distribution of second order nonlinear BBO crystal sizes and orientations scattered along the optical path of the optical fiber 100. Inducing a strain access during the draw process or creating an electrical field perpendicular to the draw axis are potential methods to align crystal orientation if uniformity is desired. Controlling the cooling temperature during the fiber draw process can produce larger or smaller crystal sizes as desired. In this manner a very large number of crystals can be produce throughout the length of the fiber in order to provide a long interaction pathlength for the source photons to interact with the crystals.

Due to the large distribution of crystals, it can be expected that polarized light propagating through the core of the fiber can show a certain probability for spontaneous parametric down conversion. If the polarization orientation of the light aligns with the fast axis of the BBO crystal at any point along the length of the BBO fiber, biphotons then have the possibility of being generated.

Additional embodiments of the present disclosure further include determining crystallization to maximize biphoton generation and locating preferred polarization directions. The probability of quantum entanglement can increase with the length of the fiber as there will be correspondingly more interactions between propagating photons and the BBO crystals. Additionally, the fiber can be drawn so that a specified shorter length on the order of decimeters contains BBO crystals while the rest of the fiber could be standard telecom allowing for long lengths of transmission.

Thus, BBO and other nonlinear crystals have shown success in producing biphotons in free space crystals. A laser beam can be directed through free space to the crystal surface by a series of mirrors, lenses, and/or other optical components. If successful, the higher energy incoming photon can be split into two lower energy photons which are polarization entangled. However, such processes can be extremely inefficient due to the low probabilities of entanglement upon interaction of a photon with the crystal and such processes require precise alignments and space to setup.

This research has been focused on producing crystals such as BBO into the optical fiber 100 either in the core or in the cladding 110 to allow the incoming higher energy photons to interact a very large number of times with the crystal or crystals contained within an optical fiber 100. The optical fiber 100 described herein can be designed like telecom optical fibers 100 able to confine light to the core region, however, alternative types of optical fibers 100 can be employed. Fibers which have been produced with BBO are shown below in FIG. 2 different core sizes and different cladding 110 glass diameters for some of the fibers which have been produced.

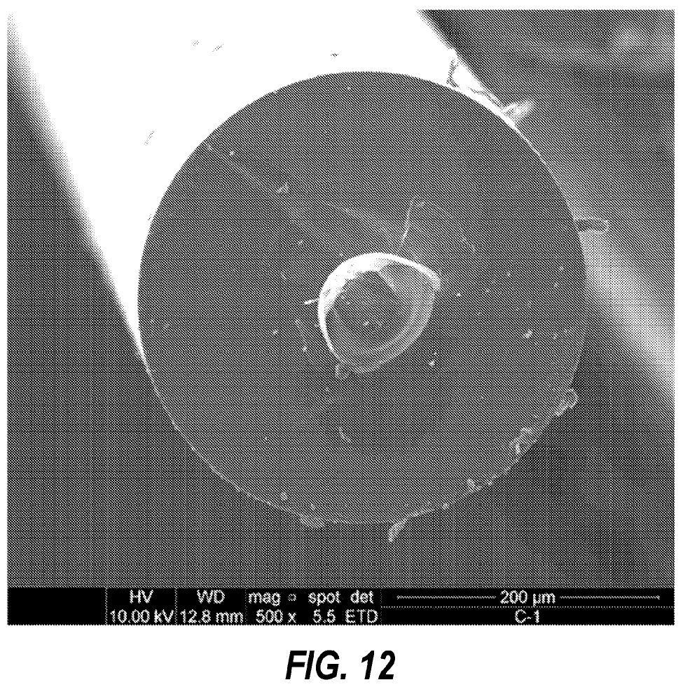

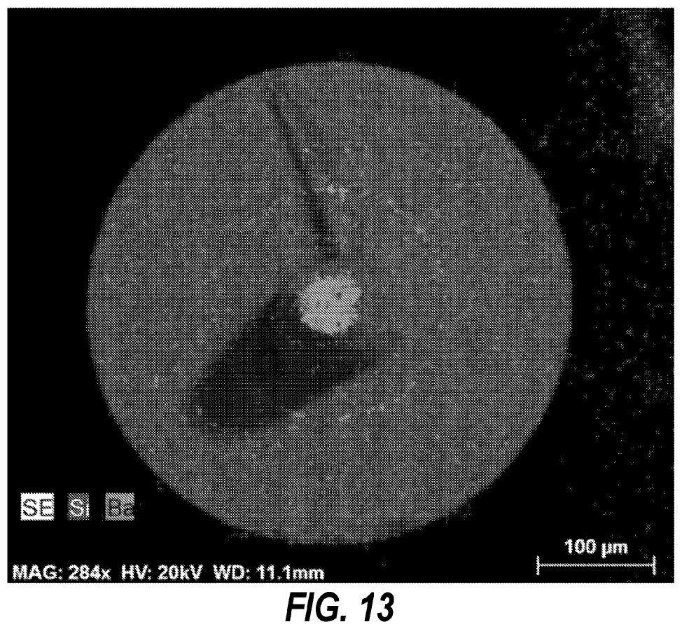

A single large crystal or a very large number of tiny crystals can be incorporated into the optical fiber 100 by controlling the time and temperature exposure. This allows high numbers of photon/crystal interactions to occur. SEM and EDX images of the fibers produced with a BBO core are shown in FIGS. 12 and 13, respectively. Fracture sections of the fibers can be used to minimize contamination of the surface. However, irregular fracture surfaces caused “shadowing” or other effects to show up as artifacts in some of the fiber samples measured. EDAX measurements of the fiber fracture cross-section in FIG. 13 show the clear delineation between the barium borate core region and the surrounding silica cladding 110.

Various configurations can be achieved between multiple crystal regions and multiple optical core regions, for further optimization. Any number of the photon entanglement media regions can be incorporated and can either be symmetrically disposed around the central core or otherwise arranged. The optical fiber 100 can be designed such that the evanescent field emanating from the core region into the cladding 110 allows for interaction of the light in the core with the photon entanglement media 105 in the cladding 110. The size of the media can range from hundreds of microns down to a few nanometers. The number of media regions can number in excess of tens of thousands for very small areas.

Thus, the size and size distribution, location, composition of the photon entanglement media 105, ordering level and number of regions can be controlled over a very wide range allowing for a multitude of future experiments to optimize the optical fiber 100 in biphoton production. To date there is no easy and efficient way to generate large quantities of biphotons inside a fiber based on the nonlinear crystals. Quantum entangled photons are being investigated for a variety of uses from sensing to imaging to communications to cryptography. Developing biphoton producing technology is critical and the method proposed for a BBO biphoton generating fiber shows promise for enhancing these applications.

The features, structures, or characteristics described above may be combined in one or more embodiments in any suitable manner, and the features discussed in the various embodiments are interchangeable, if possible. In the following description, numerous specific details are provided in order to fully understand the embodiments of the present disclosure. However, a person skilled in the art will appreciate that the technical solution of the present disclosure may be practiced without one or more of the specific details, or other methods, components, materials, and the like may be employed. In other instances, well-known structures, materials, or operations are not shown or described in detail to avoid obscuring aspects of the present disclosure.

Although the relative terms such as “on,” “below,” “upper,” and “lower” are used in the specification to describe the relative relationship of one component to another component, these terms are used in this specification for convenience only, for example, as a direction in an example shown in the drawings. It should be understood that if the device is turned upside down, the “upper” component described above will become a “lower” component. When a structure is “on” another structure, it is possible that the structure is integrally formed on another structure, or that the structure is “directly” disposed on another structure, or that the structure is “indirectly” disposed on the other structure through other structures.

In this specification, the terms such as “a,” “an,” “the,” and “said” are used to indicate the presence of one or more elements and components. The terms “comprise,” “include,” “have,” “contain,” and their variants are used to be open ended, and are meant to include additional elements, components, etc., in addition to the listed elements, components, etc. unless otherwise specified in the appended claims.

The terms “first,” “second,” etc. are used only as labels, rather than a limitation for a number of the objects. It is understood that if multiple components are shown, the components may be referred to as a “first” component, a “second” component, and so forth, to the extent applicable. If “one or more” components are described, it is understood that the term “one or more” may refer to “at least one” of the components or a “plurality of” the components unless otherwise specified.

The above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

1. A method of manufacturing an optical fiber, comprising:
providing a fiber preform with a non-linear crystal material disposed within;
heating the fiber preform until the fiber preform reaches a predetermined temperature; and
drawing the preform into an optical fiber.

2. The method according to claim 1, wherein providing the fiber preform comprises:
melting the non-linear crystal material to a temperature above a melting point of the non-linear crystal material;
inserting one end of a tube into the melted non-linear crystal material;
applying suction at another end of the tube to draw the melted non-linear crystal material into the tube; and
cooling the tube with the non-linear crystal material disposed within the tube.

3. The method according to claim 2, wherein providing the fiber preform further comprises:
inserting the tube with the non-linear crystal material into a hole formed into a larger tube preform; and
inserting an optical fiber core rod into a central hole within the larger tube preform.

4. The method according to claim 1, wherein providing the fiber preform comprises:
melting the non-linear crystal material to a temperature above a melting point of the non-linear crystal material;
melting a second non-linear crystal material to a temperature above a melting point of the second non-linear crystal material;
inserting one end of a first tube into the melted non-linear crystal material;
applying suction at another end of the first tube to draw the melted non-linear crystal material into the first tube;
inserting one end of a second tube into the second melted non-linear crystal material;
applying suction at another end of the second tube to draw the second non-linear crystal material into the second tube; and
cooling the first tube with the non-linear crystal material disposed within the first tube and cooling the second tube with the second non-linear crystal material disposed within the second tube.

5. The method according to claim 4, wherein the non-linear crystal material is different than the second non-linear crystal material.

6. The method according to claim 4, wherein the first tube comprises a first outer diameter and the second tube comprises a second outer diameter, the first outer diameter being larger than the second outer diameter.

7. The method according to claim 6, wherein providing the fiber preform further comprises:
inserting the first tube with the non-linear crystal material into a first hole formed into a larger tube preform;
inserting the second tube with the second non-linear crystal material into a second hole formed into the larger tube preform; and
inserting an optical fiber core rod into a central hole within the larger tube preform.

8. The method according to claim 7, wherein an inner diameter of the first hole is greater than an inner diameter of the second hole.

9. The method according to claim 1, wherein drawing the preform into a fiber comprises drawing the preform using a draw tower.

10. The method according to claim 1, wherein the non-linear crystal material comprises a plurality of non-linear crystal materials.

11. The method according to claim 10, wherein the plurality of non-linear crystal materials comprise a first non-linear crystal material at a first location in the fiber preform and a second non-linear crystal material at a second location in the fiber preform.

12. The method according to claim 11, wherein the non-linear crystal material comprises Barium Borate (BBO) crystals.

13. An optical device for quantum entanglement, comprising:
a photon source module configured to generate entangled photon pairs in an optical fiber comprising a non-linear crystal material disposed within;
a photon manipulation module configured to control and modify at least one entanglement property of the photon pairs; and
a photon detection module configured to measure and characterize the entangled photon pairs.

14. The optical device according to claim 13, wherein the photon source module is further configured to utilize non-linear optical processes to generate the entangled photon pairs in the optical fiber.

15. The optical device according to claim 13, wherein the photon manipulation module further comprises wave plates, polarization controllers, and beam splitters for modifying and controlling the entanglement properties of the photon pairs.

16. The optical device according to claim 13, wherein the non-linear crystal material comprises Barium Borate (BBO) crystals.

17. The optical device according to claim 13, wherein the photon detection module comprises a single-photon detector and associated electronics configured to measure and characterize the entangled photon pairs.

18. An optical fiber for generating entangled photons, comprising:
an optical core; and
photon entanglement media disposed relative to the optical core, the photon entanglement media comprising a non-linear crystal material disposed within,
wherein the non-linear crystal material is positioned in the optical fiber such that a multitude of photon and crystal interactions occur in a single transmission of photons.

19. The optical fiber according to claim 18, wherein the non-linear crystal material comprises a plurality of non-linear crystal materials.

20. The optical fiber according to claim 19, wherein the plurality of non-linear crystal materials comprise a first non-linear crystal material at a first location in the optical fiber and a second non-linear crystal material at a second location in the optical fiber.

21-27. (canceled)
